(19) United States
(12) Patent Application Publication
(10) Pub. No.: US 2002/0021307 A1
(43) Pub. Date: Feb. 21, 2002

(54) Method and apparatus for utilizing online presence information

(76) Inventors: Steve Glenn, Santa Monica, CA (US); Brett Schlank, Los Angeles, CA (US); Michael Rivera, Los Angeles, CA (US); Jim Condit, Marina del Rey, CA (US)

Correspondence Address: THE HECKER LAW GROUP, 1925 CENTURY PARK EAST, SUITE 2300, LOS ANGELES, CA, 90067, US

(21) Appl. No.: 09/840,773

(22) Filed: Apr. 23, 2001

Related U.S. Application Data
(60) Provisional application No. 60/199,275, filed on Apr. 24, 2000.

(51) Int. Cl. G06F 15/16; G09G 5/00

(52) U.S. Cl. 345/753; 709/205

(57) ABSTRACT

One embodiment of the present invention comprises a method and apparatus for utilizing online presence information. The invention comprises an interconnection fabric (e.g. a network) configured to transmit data, a plurality of client devices that are each associated with a user, a presence indicator, a presence engine, a translation engine, a communication engine, and a broadcast engine. A presence indicator is a type of cue that may be embedded into a document and configured to provide users with a mechanism for determining when another user is connected to the interconnection fabric (e.g. a visual, audio, or video cue. Each graphic is associated with a particular user and is configured to resemble the status of the user with which the graphic is associated (e.g whether a particular user is connected to the interconnection fabric). The presence engine contains software configured to determine when a user begins and ends using the network. An embodiment of the invention uses a translation engine to provide the system with the ability to translate messages. Translation engine is configured to translate between different message protocols and/or different languages. The communication engine provides a mechanism for transmitting targeted messages to users the presence engine identifies as present. The Broadcast engine is configured to transmit a message from one user to many users according to a set of criteria.

### BACKGROUND OF THE INVENTION

This non-provisional application takes priority from U.S. Provisional Application No. 60/199,275 filed on Apr. 24, 2000.

### 1. FIELD OF THE INVENTION

This invention relates to the field of computer software, and more particularly to a method and apparatus for utilizing online presence information.

2. BACKGROUND

Current network systems (such as the Internet discussed in further detail below) provide a way to transmit message data to other users connected to the network. For example, electronic mail and instant messaging client programs enable users to send and receive messages. However, such network-based systems do not provide users with a way to individually generate and control a presence indicator and then provide a mechanism for automatically opening different forms of communication interfaces when another user selects the presence indicator.

Another problem with current systems is that anonymous/unregistered users cannot select a presence indicator and open a communication interface to the user associated with the presence indicator. Moreover, such systems do not provide anonymous users with alternative communication interfaces based upon whether the user associated with the presence indicator is online. The prior art does not provide anonymous users with a way to determine if a user is online, open an instantaneous communication interface when a particular user is online, and a delayed communication interface when that same user is offline.

The prior art also lacks a system that provides seamless interoperability between differing client programs. For example, AOL Instant Messaging (IM) users may only send messages to other AOL IM users. Thus, current network based systems, lack the ability to provide users with a way to establish a communication channel with users who are presently connected to the network, but are utilizing different protocols for sending instantaneous message data to one another.

### A. General Background Material About Computer Networks

In order to facilitate an understanding of how computer networks allows for the transfer of data a brief discussion about such networks is provided. Computers and computer networks are used to exchange information in many fields such as media, commerce, and telecommunications, for example. The exchange of information between computers typically occurs between a “server application” that provides information or services, and a “client application” or device that receives the provided information and services. Multiple server applications are sometimes available on a “system server” such as a single computer server that provides services for multiple clients. Alternatively, distributed server systems allow a single client to obtain services from applications residing on multiple servers. For example, in current distributed server systems, client applications are able to communicate with server applications executing on the same computer system or on another computer system accessible via a network, for instance via the Internet.

The Internet is a worldwide network of interconnected computers. An Internet client computer accesses a computer on the network via an Internet provider. An Internet provider is an organization that provides a client (computer) with access to the Internet (via analog telephone line or Integrated Services Digital Network line, for example). A client can, for example, read information from, download a file from, or send an electronic mail message to another computer/client using the Internet.

To retrieve a file or service on the Internet, a client must typically search for the file or service, make a connection to the computer on which the file or service is stored, and download the file or access the service. Each of these steps may involve a separate application and access to multiple, dissimilar computer systems (e.g. Computer systems having operating different systems). The World Wide Web (WWW) was developed to provide a simpler, more uniform means for accessing information on the Internet.

The components of the WWW include browser software, network links, servers, and WWW protocols. The browser software, or browser, is a tool for displaying a user-friendly interface (i.e., front-end) that simplifies user access to content (information and services) on the WWW. Browsers use standard WWW protocols to access content on remote computers running WWW server processes. A browser allows a user to communicate a request to a WWW server without having to use the more obscure addressing scheme of the underlying Internet. A browser typically provides a graphical user interface (GUI) for displaying information and receiving input. Examples of browsers currently available include Netscape Navigator and Communicator, and Microsoft Internet Explorer.

WWW browsers and servers communicate over network links using standardized messages formats called protocols. The most common modern protocol is the TCP/IP (Transmission Control Protocol/Internet Protocol) protocol suite. The protocols are based on the OSI (Open Systems Interconnect) seven-layered network communication model for information transport. WWW messages are primarily encoded using Hypertext Transport Protocol (HTTP). HTTP instantiates the (top) Application layer of the OSI model. Application layer protocols facilitate remote access and resource sharing and are supported by the reliable communications ensured by the lower layers of the communications model. Therefore, HTTP simplifies remote access and resource sharing between clients and servers while providing reliable messaging on the WWW.

Information servers maintain the information on the WWW and are capable of processing client requests. HTTP has communication methods that allow clients to request data from a server and send information to the server. To submit a request, the client browser contacts the HTTP server and transmits the request to the HTTP server. The request contains the communication method requested for the transaction (e.g., GET an object from the server or POST data to an object on the server). The HTTP server responds to the client by sending a status of the request and the requested information. The connection may then be terminated between the client and the HTTP server.

A client request, therefore, consists of establishing a connection between the client and the HTTP server, performing the request, and terminating the connection. The HTTP server typically does not retain any information about the request after the connection has been terminated. That is, a client can make several requests of an HTTP server, but each individual request is treated independent of any other request.

The WWW employs an addressing scheme is that uniquely identifies Internet resources (e.g., HTTP server, file, or program) to clients and servers. This addressing scheme is called the Uniform Resource Locator (URL). A URL represents the Internet address of a resource on the WWW. The URL contains information about the protocol, Internet domain name and addressing port of the site on which the server is running. It also identifies the location of the resource in the file structure of the server. HTTP provides a mechanism of associating a URL address with active text. A browser generally displays active text as underlined and color-coded. When activated (by a mouse click, for example) the active text causes the browser to send a client request for a resource to the server indicated in the text's associated URL address. This mechanism is called a hyperlink. Hyperlinks provides the ability to create links within a document to move directly to other information. A hyperlink can request information stored on the current server or information from a remote server.

If the client requests a file, the HTTP server locates the file and sends it to the client. An HTTP server also has the ability to delegate work to gateway programs. The Common Gateway Interface (CGI) specification defines a mechanism by which HTTP servers communicate with gateway programs. A gateway program is referenced using a URL. The HTTP server activates the program specified in the URL and uses CGI mechanisms to pass program data sent by the client to the gateway program. Data is passed from the server to the gateway program via command-line arguments, standard input, or environment variables. The gateway program processes the data and returns its response to the server using CGI (via standard output, for example). The server forwards the data to the client using the HTTP.

When a browser displays information to a user it is typically as pages or documents (referred to as “web pages”). The document encoding language used to define the format for display of a Web page is called Hypertext Markup Language (HTML). A sever sends a Web page to a client in HTML format. The browser program interprets the HTML and displays the Web page in a format based on the control tag information in the HTML.

### SUMMARY OF THE INVENTION

One embodiment of the present invention comprises a method and apparatus for utilizing online presence information. The invention comprises an interconnection fabric configured to transmit data, a plurality of client devices that are each associated with a user, a presence indicator, a presence engine, a communication engine, and a broadcast engine. Each of these elements provides the system with functionality that is further described below.

Presence Engine:

The presence engine contains software configured to determine when a user begins and ends using the network. When a client device (e.g. a computer, pager, cell phone, or other communication device) establishes a connection to the interconnection fabric, the client device (or client program) transmits a message to the communication engine and the information about the user being connected is then passed on to the presence engine indicating that the user associated with that client device is presently connected to the interconnection fabric. The presence engine retains this information in a format that is accessible to other client devices. When the other client devices are directed to determine which users are presently connected to the network, the devices may do so by querying the presence engine. When the user of a client device stops using the network (e.g. by logging off or closing a web browser), the presence engine checks to see if the user is simultaneously connected via a different client device. If no client devices associated with the relevant user are connected to the network, the presence engine notes that the user is no longer online. Therefore, the presence engine contains a list of users that are presently connected to the network.

Presence Indicator:

The information retained by the presence engine is communicated to each client device in a binary fashion. When the client device receives the binary information it displays a presence indicator. The presence indicator is a cue that provides users with a way to determine what other users are connected to the network (e.g. a visual, audio, or video cue).

In one embodiment of the invention, the presence indicator is a graphic that is displayed on a web page. The graphic has multiple states and is associated with a particular user. The graphic is designed to communicate the status of the user with which the graphic is associated. In one state, the graphic indicates that a particular user is connected to the interconnection fabric. In a second state, the graphic indicates that the same user is not using the network. The presence indicator may also be an audio or video cue configured to communicate the states discussed above.

Translation Engine:

If a user selects a presence indicator associated with a particular user, a communication module that provides a communication channel to that user will open. If the presence indicator is in the online state, a text message may be instantaneously transmitted to the user associated with the presence indicator. If the presence indicator is in the offline state, several alternative modes of communication are available. For example, the message may be stored in a queue until the user logs onto the network or the message may be transmitted to the user via electronic mail.

In one embodiment of the invention, the communication module contains a translation engine configured to translate between different message protocols and/or different languages. The translation engine, for example, can convert a foreign protocol to the communication engine's protocol and vice-versa. The translation engine may convert message data that is sent in a first protocol (e.g. the AOL instant messaging protocol) into data that conforms to the communication server's native protocol. Thus, the translation engine provides users that have incompatible client applications with the ability to send messages to one another. The client software utilized to display the message data (e.g. a reader) may be transmitted to the client device along with the message data. Thus, the present invention does not require users to install a special application program for sending message data on the client device.

Communication Engine:

The communication engine provides a mechanism for transmitting targeted messages to users the presence engine identifies are present. An embodiment of the invention contemplates using the communication engine to send time critical information from one user to another (e.g. one-to-one).

Broadcast Engine:

The broadcast engine provides a mechanism for transmitting a message from one user to many users according to a set of criteria. For example, the broadcast engine may provide the user with stock quotes, the closing information related to an auction the user is interested in, or any other information the user expresses an interest in receiving may be transmitted from one user to another using the communication engine. In an embodiment of the invention the broadcast engine may deliver a single message to many users by generalizing the message into a one-to-many message. The criteria used to determine which recipients to transmit the message data to may be based on membership in a group, demographic information, or any other type of filtering criteria. If the client device associated with the intended recipient is not online when the broadcast engine transmits a message, the broadcast engine may elect to delay transmission until the recipient connects to the interconnection fabric. The broadcast engine may also elect to send an electronic mail message rather than instantaneously transmitting a text message to a user that is not currently connected to the interconnection fabric. Alternatively, the broadcast engine may decide to wait for a duration of time in order to watch for a particular action (e.g. to see if the intended recipient comes online). If the action being watched for does not occur, the broadcast engine may send an electronic mail message at the expiration of the allotted time period.

### BRIEF DESCRIPTION OF THE DRAWINGS

FIG. 1 shows an example of the components utilized by one embodiment of the invention.

FIG. 2 comprises an illustration of several of the components of the invention in an offline state.

FIG. 3 comprises an illustration of several of the components of the invention in an online state.

FIG. 4 is a flow diagram that illustrates the process used by one embodiment of the invention to determine which interface to present to the initiating user when the presence indicator is selected.

FIG. 5 is a flow diagram that illustrates the process utilized by an embodiment of the invention when a query is transmitted to the presence engine.

FIG. 6 illustrates the prcess utilized by an embodiment of the invention to evaluate and translate messages.

FIG. 7 illustrates the process utilized by the translation engine when the translation engine is configured to act on behalf of a client program and thereby communicate with a foreign protocol.

FIG. 8 is a block diagram of an example of a general-purpose computer system in which an embodiment of the invention may be implemented.

FIG. 9 illustrates the components of the communication engine in one embodiment of the invention.

FIG. 10 illustrates the thread management scheme utilized by one embodiment of the invention.

FIG. 11 illustrates the internal class structure of the connection server in one embodiment of the invention.

### DETAILED DESCRIPTION OF THE INVENTION

The present invention is a method and apparatus for utilizing online presence information. An embodiment of the invention provides user with a mechanism for initiating instantaneous and/or delayed communication channels depending upon whether the receiving user is currently connected to an interconnection fabric. In the following description, numerous specific details are set forth to provide a more thorough description of the present invention. It will be apparent, however, to one skilled in the art, that the present invention may be practiced without these specific details. In other instances, well known features have not been described in detail so as not to obscure the present invention.

System Overview:

The invention provides user with a simplistic mechanism for initiating instantaneous and/or delayed communication channels depending upon whether the receiving user is currently connected to an interconnection fabric. The invention comprises the interconnection fabric configured to transmit data, a plurality of client devices that are each associated with a user and configured to run client programs, a presence indicator, a presence engine, a communication engine, and a broadcast engine. An embodiment of the invention provides a mechanism for translating between multiple types of protocols. Each of these components may be located on a single server computer or split across one or more server computers. A brief overview of these elements and the functionality associated with each element follows.

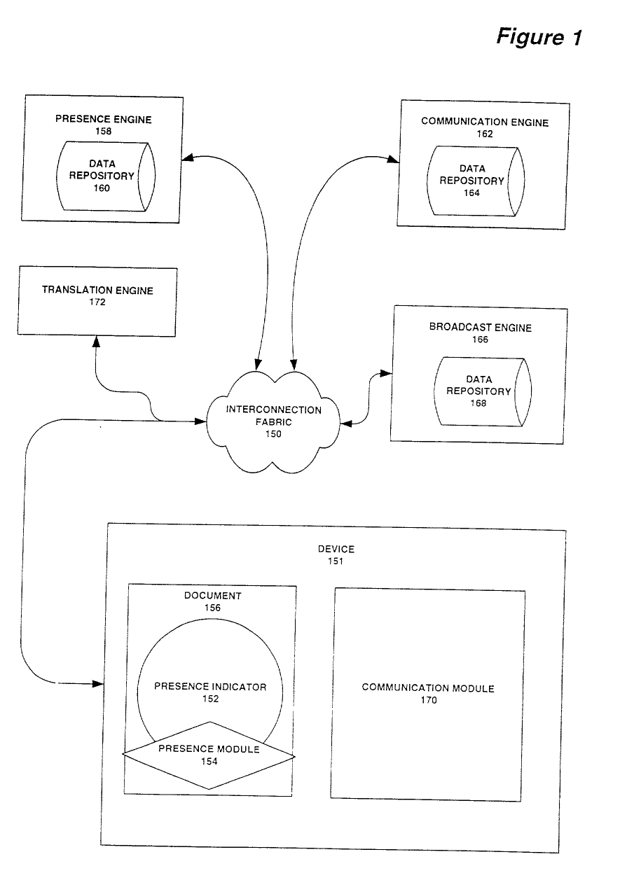

Referring now to FIG. 1, an example of the interrelationship between some of the components utilized by one embodiment of the invention is shown. In one or more embodiments of the invention, interconnection fabric 150 comprises any of multiple suitable communication paths for carrying data between multiple computational devices and/or client programs. Interconnect fabric 150 may be, for example, a local area network implemented as an Ethernet network, a virtual private network, or any other type of interconnect cable of sending data from one device to another. Interconnect fabric 150 may be implemented with a physical medium such as a wire or fiber optic cable, or it may be implemented in a wireless environment. Hereinafter, the term network refers to any type of interconnection fabric that provides computers with a mechanism for transmitting and/or receiving data (e.g., intranets, local area networks, wide area networks, wireless networks, distributed server systems, or client/server architectures). Presence indicator 152 is a type of cue configured to provide users with a mechanism for determining when another user is connected to the interconnection fabric (e.g. a visual, audio, or video cue). Presence indicator 152 is configured for display on any type of device 151 connected to interconnection fabric 150.

The functionality and appearance of presence indicator 152 is controlled in one embodiment of the invention by presence module 154. In an embodiment of the invention, presence module 154 is the source code module responsible for generating presence indicator 152 and may be embedded into varying types of documents 156. Presence module 154 may be configured to change the appearance and functionality of presence indicator 152 depending upon whether the user associated with presence indicator 152 is online or offline. Presence module 154 determines whether the user associated with presence indicator 152 is online by transmitting a query to presence engine 158. Presence engine 158 is configured to process the query and return a result that specifies whether the user associated with presence indicator 152 is online or offline. Presence engine 158 may store information about the user, such as a list of users online in data repository 162. However, such user information may also be communicated directly to a client device. The system may use a single data repository or a combination of several different repositories. Each repository may represent a single table of data and/or a database containing multiple tables.

If a user of device 151 selects presence indicator 152, communication module 170 opens. Communication module 170 comprises an instant messaging program, chat program, or any other type of program configured to send instantaneous message data between users. If presence indicator 152 is in a first state, a text message may be instantaneously transmitted to the user associated with presence indicator 152 once communication module 170 opens. If presence indicator 152 is in the second state, several alternative modes of communication are available. For example, the message may be stored in a queue until the user logs onto the network or the message may be transmitted to the user via electronic mail.

In an embodiment of the invention, communication module 170 utilizes translation engine 172. Translation engine 172 may be encompassed into communication module 170 or resides on a separate server computer accessible via interconnection fabric 150. Translation engine 172 is configured to translate between different message protocols and/or different languages. Translation engine 172, for example, can convert message data that is sent in a first protocol (e.g. a native protocol) into data that conforms to a second protocol (e.g. a foreign protocol) and vise-versa. Thus, translation engine 172 provides users that have incompatible client applications with the ability to send messages to one another.

Translation engine 172 may also translate messages sent in a first language to a second language. If, for example, a user sends a message in English, but the recipient has indicated a language preference of Spanish, translation engine 172 may convert the message to Spanish. Translation engine 172 may, for example, interface with translation software such as Systran Enterprise™ or utilize network based translation mechanisms such as babelfish.altavista.com™. In an embodiment of the invention, translation engine 158 converts both protocol and languages. However, translation engine may be configured to convert protocols or language data. Communication module 170 may take the form of an applet and be transmitted to the client device along with the message data. Thus, an embodiment of the present invention does not require users to install a special application program for sending message data on the client device.

Communication engine 162 provides an embodiment of the invention with a mechanism for transmitting targeted messages to users presence engine 158 identifies as present. Communication engine 162 may, for example, send time critical information from one user to another (e.g. one-to-one). In one embodiment of the invention an external agent provides the information disseminated by communication engine 162. Data repository 164 holds information associated with the transmission of targeted messages and may, for example, contain criteria that define when such messages are to be transmitted.

Broadcast engine 166 is configured to transmit a message from one user to many users according to a set of criteria. For example, broadcast engine 166 may transmit a targeted message to the user when a certain action occurs (e.g. when a stock reaches a certain price). The broadcast engine 166 may deliver a single message to many users by generalizing the message into a one-to-many message. The criteria used to determine which recipients to transmit the message data to may be based on membership in a group, demographic information, or any other type of filtering criteria. In one embodiment of the invention, the messages transmitted by broadcast engine 166 comprise advertisements and/or other information to user who are online. Thus, broadcast engine 166 may instantaneously transmit messages to any members of a group who are online (e.g. via an instant messaging client). In one embodiment of the invention, broadcast engine 166 uses communication engine 162 to transmit data. If the members of that group are not presently online, broadcast engine 166 may automatically send the message data via electronic mail. Each message may contain functionality that allows the user to fashion a response to the message. The message may, for example, contain an embedded coupon that allows the receiving user to receive a discount on a particular item if the user clicks on the message. Message recipients may also subscribe to a service by selecting the message.

A more detailed discussion of the components and processes utilized in one or more embodiments of the invention follows.

Presence Indicator:

A presence indicator is a type of cue configured to provide users with a mechanism for determining when another user is connected to the interconnection fabric (e.g. a visual, audio, or video cue). In one embodiment of the invention, the presence indicator is set of one or more graphics that may be embedded into a document. Each graphic is associated with a particular user and is configured to resemble multiple states. The graphic, for example, may be designed to communicate the status of the user with which the graphic is associated. In one state, the graphic has an appearance that indicates whether a particular user is connected to the interconnection fabric. In a second state, the graphic indicates that the same user is not currently using the network. The graphic may also have alternative states that indicate, for example, that the user is online but does not wish to be disturbed. The presence indicator may also be an audio or video cue configured to communicate the states discussed above.

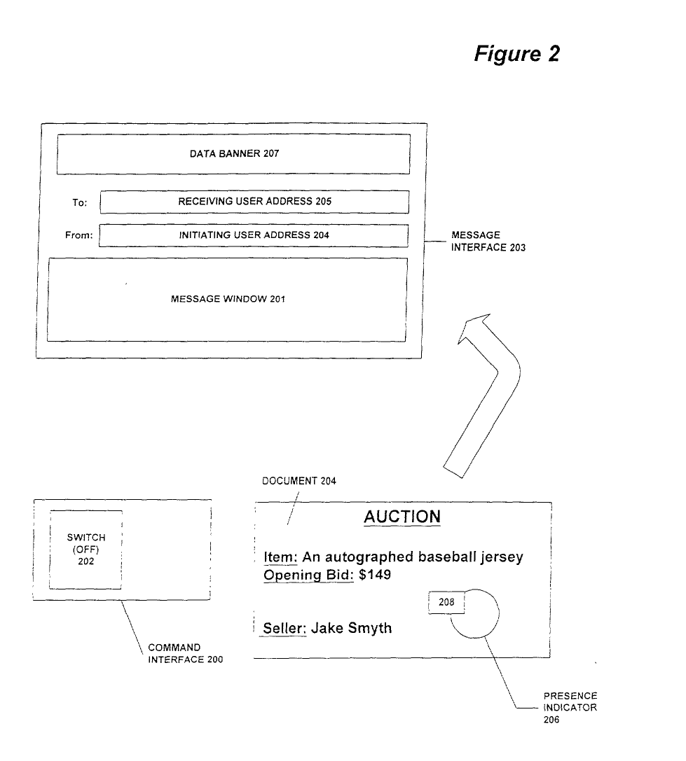

FIG. 2, shows an example of the command interface used to control the state of a presence indicator. Command Interface 200 provides users with a mechanism for controlling the appearance and/or state of presence indicator 206. Command interface 200 may reside on any computer connected to the interconnection fabric so long as the interface is accessible to the user wishing to define an online presence. The user may, for example, access command interface 200 via a web browser or the user may execute command interface on a local client computer. In one embodiment of the invention, command interface 200 is an executable program configured to interface with a presence engine. The presence engine specifies when the user associated with the presence indicator is connected to the interconnection fabric and willing to receive message data.

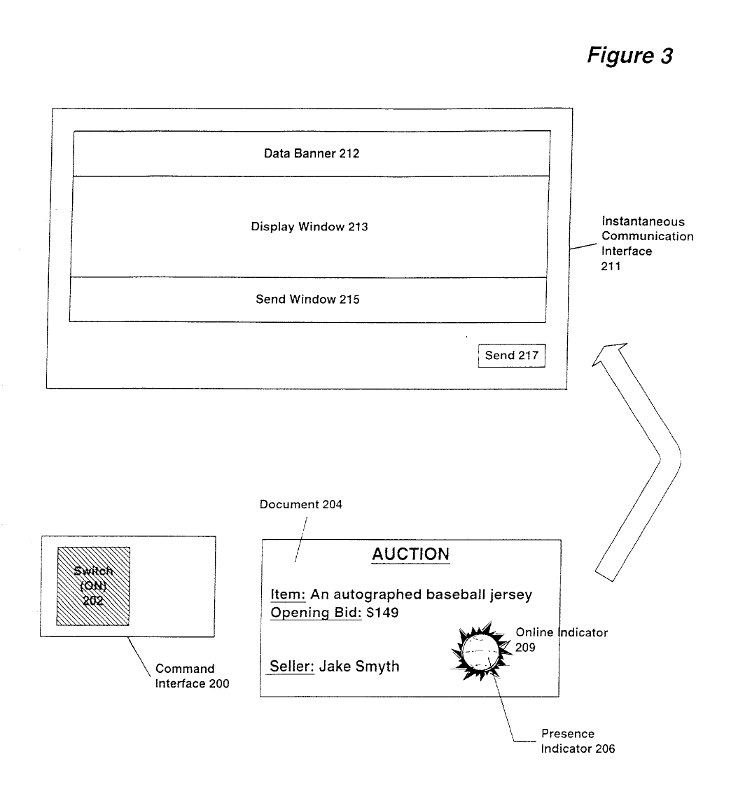

Command interface 200 comprises one or more components that allow a message recipient (e.g. a receiving user) to specify when and how the recipient wishes to receive message data. Thus, command interface 200 allows the receiving user to dictate what type of message data an initiating user may transmit when the initiating user selects or clicks on the presence indicator associated with the receiving user. One embodiment of the invention contemplates using command interface 200 to define whether or not a receiving user is indicated as present. In one embodiment of the invention, for example, command interface 200 comprises switch 202. Switch 202 provides the receiving user with a mechanism for specifying the appearance and functionality of the presence indicator associated with that user. The appearance of the presence indicator may dictate what form of communication interface (e.g. message interface 202) will initiate when an initiating user selects presence indicator 206. When the receiving user places switch 202 in an OFF position (see e.g. FIG. 2), presence indicator 206 comprises an offline indicator 208 which shows that the receiving user is not online. When switch 202 is in an ON position (see e.g. FIG. 3), presence indicator 206 shows that the receiving user associated with command interface 200 is online. Thus, the appearance of presence indicator 206 depends upon the position the receiving user has set switch 202.

In one embodiment of the invention, presence indicator 206 is embedded into document 204. Document 204 comprises any type of document that may be sent across an interconnection fabric (e.g. an HTML document) and displayed by a client program. The functionality associated with presence indicator 206 is related to its appearance. When switch 202 is in the OFF position, selecting offline indicator 208 presents message interface 203. Message interface 203 provides a mechanism for collecting data from the initiating user and transmitting it to the receiving user. Message interface 203 comprises an electronic mail client having message window 201 and locations identifying a receiving user address 205 and an initiating user address 204. Message interface 203 may also comprise data banner 207. In one embodiment of the invention, message interface 203 is configured to send the collected data to a queue or delayed relay for later transmission to the receiving user. If, for example, the initiating user clicks on offline indicator 208 opens a window message interface 203 that provides a location for entering an electronic mail message (e.g. message window 201). In one embodiment of the invention, offline indicator 208 comprises a hypertext link which points to message interface 203. When the hypertext link is selected, message interface 203 opens. Message interface 203 comprises a client program configured to execute on the initiating user's computer and may, for example, be an applet program, a browser based program, or any other type of executable program configured to provide the initiating user with a location for entering and sending electronic mail messages.

Once the initiating user enters an electronic mail message in the appropriate window, message interface 202 transmits the electronic mail to a message queue associated with the receiving user. When the receiving user connects to the interconnection fabric, the user may retrieve the electronic mail from the message queue and/or the electronic message data may be automatically forwarded to the location where the receiving user resides. Message interface 202 may be configured to present the user with any other type of delayed communication mechanisms. For example, message interface 202 may comprise a telephonic voice mail interface or an alphanumeric pager interface.

When switch 202 is in the ON position, presence indicator 106 takes a different form than it does with switch 202 in the OFF position (see e.g. FIG. 3). When switch 202 is in the ON position presence indicator 206 comprises an online indicator 209. Online indicator 209 modifies presence indicator in such a way that the initiating user can determine by glancing at presence indicator 206 whether the receiving user is connected to the interconnection fabric. For example, presence indicator 206 may comprise a unique color and/or shape that is only present when the receiving user is online. In one embodiment of the invention, for example, presence indicator changes from white to yellow when the user turns switch 202 to the ON position.

When presence indicator 206 comprises online indicator 209 (e.g. when switch 102 is in the ON position), the functionality associated with clicking on presence indicator 206 is different than when presence indicator 206 comprises offline indicator 208. In one embodiment of the invention, online indicator 209 comprises a hypertext link which points to instantaneous communication interface 211. Selecting presence indicator 206, for example, executes an instantaneous communication interface 211. Instantaneous communication interface 211 comprises an executable computer program configured to transmit data entered into send window 215 directly to the client computer at which the receiving user resides. In one embodiment of the invention, for example, instantaneous communication interface 211 comprises a client program configured to send data to an instant messaging client that resides at the receiving user's computer when send button 217 is selected. If the receiving user responds to the communication, the response is displayed in display window 213. Instantaneous communication interface 211 may also comprise data banner 212. The data displayed in data banner 212 is obtained in one embodiment of the invention from a broadcast server.

One embodiment of the invention contemplates transmission between multiple types of instant messaging clients and contains support for translating between multiple kinds of protocols. For example, the system may translate from a foreign protocol to the protocol utilized by the communication engine and vise versa. For example, instantaneous communication interface 211 may transmit a protocol such as the Peoplelink™ protocol (e.g. a native protocol) and the receiving user's client program may transmit a different protocol (e.g. a foreign protocol). The protocol translation may take place at the client program responsible for executing instantaneous communication interface 211 and/or at a translation engine tasked with handling the translation process. The process utilized to translate between protocols is discussed in further detail below.

Document 204 is an example of the type of document presence indicator 206 may be embedded into. Presence indicator 206 is typically embedded into a document such as document 204 by inserting a presence module into the file comprising the document. If document 204 is a web page, for example, presence module may comprise code written using a markup language such as HTML, XML, or SGML. However, a presence module may be inserted into any type of document that is to be displayed at the client computer. Presence module comprises code configured to display presence indicator 206 in document 204. In one embodiment of the invention, for example, presence indicator 206 comprises a .GIF file or any other type of image data file capable of storing pixel data.

The following HTML code, for example, if placed in a client program capable of parsing HTML will present a graphical representation of a presence indicator and interface with a presence engine to determine if the user associated with the graphic is present at the time the HTML is displayed:

<IMG border=0 src=“http://community.presence.com/
cgi-bin/pl_pres.cgi?status=jake_smyth@peoplelink.com&amp;
ret=porch1” useMap=#jake@fol NOSEND=“1”>
<MAP name=jake@fol>
<AREA coords=0,0,79,20 href=“http://community.presence.com/im/
plink.htm?buddy=jake_smyth@peoplelink.com” shape=RECT>
</AREA>
</MAP>

The information retained by the presence engine is communicated to each client device in a binary fashion. When the client device receives the binary information it displays presence indicator 206 in the appropriate form.

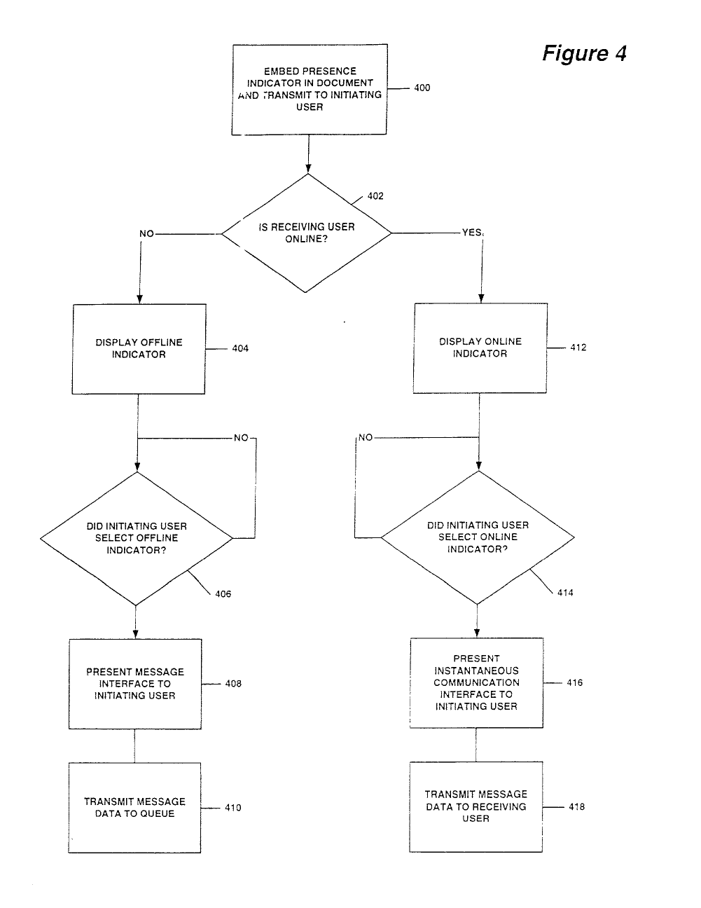

FIG. 4 is a flow diagram that illustrates the process used by one embodiment of the invention to determine which interface to present to the initiating user when the presence indicator is selected. The process begins at step 400 where a presence indicator is embedded into a document and transmitted to an initiating user. At step 402, the presence indicator determines whether the receiving user is online or offline and then displays the corresponding status of the user. In one embodiment of the invention, the process determines whether the receiving user is online by querying a presence engine. The presence engine contains software configured to determine when a user begins and ends using the network. If the query shows the receiving user is offline, the presence indicator comprises an offline indicator (e.g. step 404). If the query shows the user is online, the presence indicator comprises an online indicator (e.g. step 412). At step 406, the process waits until the initiating user selects the offline indicator. If the initiating user selects the offline indicator step 408 executes and the process presents a message interface to the initiating user. The message interface provides the initiating user with a location for entering text, image, binary, and/or voice data. Once the initiating user enters the data the process executes step 410, where the data is transmitted to a queue. In one embodiment of the invention, the data is stored in at the queue until the receiving user connects to the interconnection fabric.

If the user is online, step 414 executes. At step 414, the process waits until the initiating user selects the online indicator. If the initiating user selects the online indicator, an instantaneous communication interface is presented to the user (e.g. step 416). The initiating user may then enter text, voice, binary and/or image data into the interface and execute step 418 where the entered data is transmitted to the receiving user.

Presence Engine

The presence module associated with each presence indicator is configured to obtain information from the presence engine. In one embodiment of the invention, the presence engine contains software configured to determine when a user begins and ends using the network. This information is utilized to determine whether to show an online indicator or an offline indicator. For example, when a client device (e.g. a computer, pager, cell phone, or other communication device) establishes a connection to the interconnection fabric, the client device transmits a message to the presence engine indicating that the user associated with that client device is presently connected to the interconnection fabric. The presence engine retains this information in a format that is accessible to other client devices. When the other client devices are directed to determine which users are presently connected to the network, the devices may do so by querying the presence engine. When the user of a client device stops using the network (e.g. by logging off or closing a web browser), the presence engine checks to see if the user is simultaneously connected via a different client device. If no client devices associated with the relevant user are connected to the network, the presence engine notes that the user is no longer online. Therefore, the presence engine contains a list of users that are presently connected to the network.

In one embodiment of the invention, presence engine is a scalable system configured to support a minimum of 1000 concurrent transactions. When a client device transmits a status query to the presence engine, the presence engine returns online presence information associated with the user identified in the query. A user is flagged as online when the user connects to the interconnection fabric via a client program and/or indicates via a command interface that the user is presently available online. The presence engine is designed to track and return information about multiple types of client programs and may, for example, be configured to determine when a user logs into the interconnection fabric with any one of multiple types of client programs. If, for example, the user connects using a client program such as AOL™ Instant Messenger, the user may indicate presence by using the command interface to transmit an online state.

In one embodiment of the invention, the presence engine stores other information associated with the receiving user. The presence engine may, for example, store information about the number of presence indicator clicks the receiving user has responded to in the past. The presence engine may also contain a list of initiating users the receiving user does not wish to receive communication from. Thus, the presence engine provides a mechanism for filtering out users who abuse the presence indicator. In one embodiment of the invention, the presence engine is configured to store information generally associated with the user's presence. For example, information such as the number of presence indicator owners currently online, the number of clicks each presence indicator owner has received, and the last time the owner of the presence indicator logged in may also be stored on the presence engine. The presence engine may also store other presence related information, such as the time a particular user has stayed online, a list of which other users can see that a particular receiving user is online, state information associated with each user (e.g. which client program a user uses), whether the user has voice chat capabilities, and what language the user speaks. The presence engine may also track whether a particular user or group of users (referred to as a buddy) is online. If such a user does come online, the other users interested in that user's presence may be apprised of the user's presence.

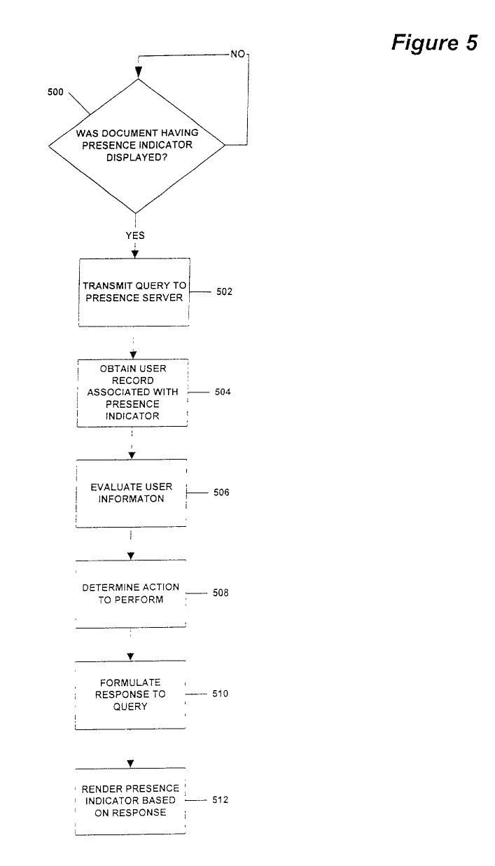

FIG. 5 is a flow diagram that illustrates the process utilized by an embodiment of the invention when a query is transmitted to the presence engine. The presence module associated with each presence indicator contains the location of the presence engine. When an initiating user opens a document that comprises a presence indicator (e.g. step 500), step 502 executes and a query is transmitted to the presence engine to determine the status of the user associated with the displayed presence indicator. The presence engine then obtains the user record associated with the presence engine (e.g. step 504). In one embodiment of the invention, the user record comprises information about the user's preferences and the user's client programs. The response to the initial query is formulated based on the information in the record as defined by the receiving user. Thus, once the presence engine obtains the user record it evaluates the information associated with the user (e.g. step 506) and then uses that information to determine what course of action to perform (e.g. step 508).

The course of action that is to be performed depends upon the preferences expressed by the user. For example, the user may wish for the presence indicator associated with the user to show the user is online at one location (e.g. the user's homepage), but not show the user as online when the user is in another location (e.g. in a pending auction or electronic mail message). The user may also wish to be shown as offline when the user is connected and using a certain client program. Thus, the presence engine is configured to determine which client program(s) the receiving user has, whether the user is currently connected using one of those programs, and what the user's preferences are with regard to that client program. The information typically required to make this determination may be obtained from the receiving user when the user registers. For example, when the receiving user registers the user provides a list of the type of client programs the user has configured on the user's computer and the nickname/password information associated with each client program. If, for example, the user has an MSN™ Instant Messaging account and an AOL™ Instant Messaging account, the user would provide the nickname/password associated with each account. The user may also specify preferences associated with each client program during registration. For example, if the user does not wish to be flagged as online when using one client program, but wishes to be considered online when using a second client program, the user may specify this preference. These and other such factors are taken into account when the presence engine formulates a response to the initial query.

At step 510, the presence engine formulates a response to the query. In one embodiment of the invention, the response returns an online flag if the presence engine determines the user wishes to be flagged as online and an offline flag if the presence engine determines the user is to be considered offline. The response thereby determines the appearance and functionality of the presence indicator. Thus, when the presence indicator is rendered for display at step 512 the appearance of the presence indicator is based on the user's status as stored in the presence engine.

Translation Engine

An embodiment of the invention uses a translation engine to provide the system with the ability to translate messages. For example, the translation engine may translate from a foreign protocol to a native protocol and back. Translation engine may be encompassed into a client program or resides on a separate server computer accessible via the interconnection fabric. Translation engine is configured to translate between different message protocols and/or different languages.

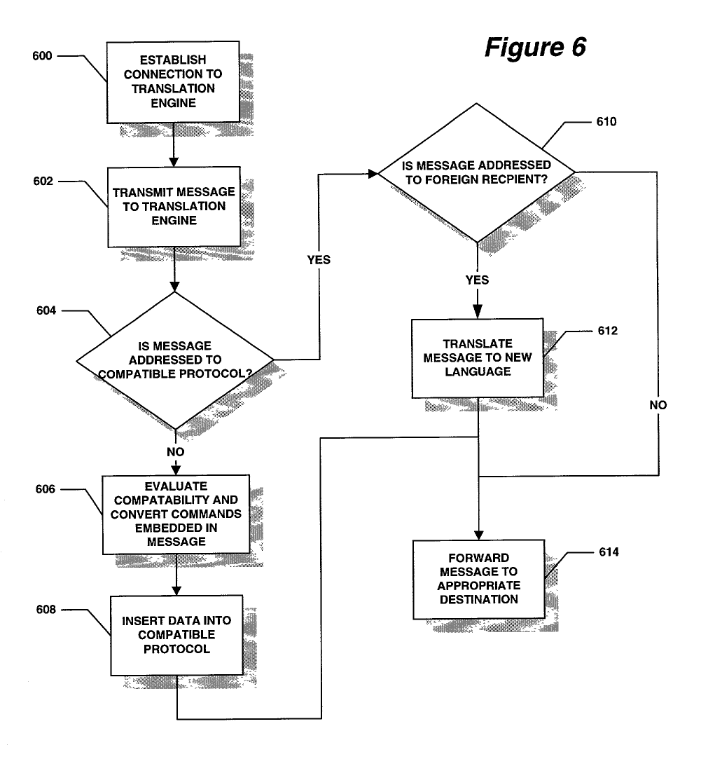

FIG. 6 illustrates the process utilized by an embodiment of the invention to evaluate and translate messages. When a client program such as an instant messaging program initiates a communication session, the client program begins by connecting to a server computer (e.g. step 600). For example, a client program may send a message to the communication engine which in turn interfaces with the server computer. In an embodiment of the invention, the server computer comprises a translation engine and any other modules necessary to provide instant messaging functionality to the client program. Once a connection to the translation engine is initiated, the client program transmits a message to the translation engine (e.g. step 602). The message comprises data such as text, audio, and/or video data and conforms to a certain protocol. In one embodiment of the invention, for example, messages are initially sent using a native protocol. The native protocol is an identifiable protocol that selected for use on the system (e.g. the AOL instant messaging protocol). Other protocols, such as the MSN instant messaging protocol or the ICQ protocol are referred to as foreign protocols. The translation engine is capable of processing messages transmitted in both foreign and native protocols.

At step 604, the translation engine determines whether the message is directed to a recipient program configured to understand the same protocol. If the message is not addressed to a compatible protocol, step 606 executes and the protocol the message is sent in is evaluated to determine compatibility with the protocol it will be converted into. In an embodiment of the invention, step 606 comprises evaluating the command messages embedded in the message and determining if it will be necessary to convert certain commands into a different format. The invention contemplates the use of a lookup table or any other mechanism for converting such commands. Once the system determines that the commands embedded in the message will be understood by the foreign protocol, step 608 executes and the system inserts the data associated with the message (e.g. the text, audio, or video data) into packets that utilize the foreign protocol. Once the message is properly encapsulated into a packet using the foreign protocol, step 614 executes. At step 614 the message is forward to the appropriate destination. For example, the message may be forwarded to the intended recipient or a proxy acting on behalf of the recipient. If the result of step 604 is that the message is addressed to a compatible protocol, step 610 may optionally execute. At step 610, the system determines if the message is addressed to a foreign recipient. A foreign recipient is a recipient who indicates a language preference different than the language the message originally contained. If, for example, a user sends a message in English, but the recipient indicates a language preference of Spanish, step 610 will flag the message as addressed to a foreign recipient. At step 612, translation engine translates the content of the message (e.g. voice or text data) from a first language to a second language. In an embodiment of the invention, translation engine may, for example, interface with translation software such as Systran Enterprise™ or utilize network based translation mechanisms such as babelfish.altavista.com™. Once the message is translated, step 614 executes and the message is forwarded to the intended recipient.

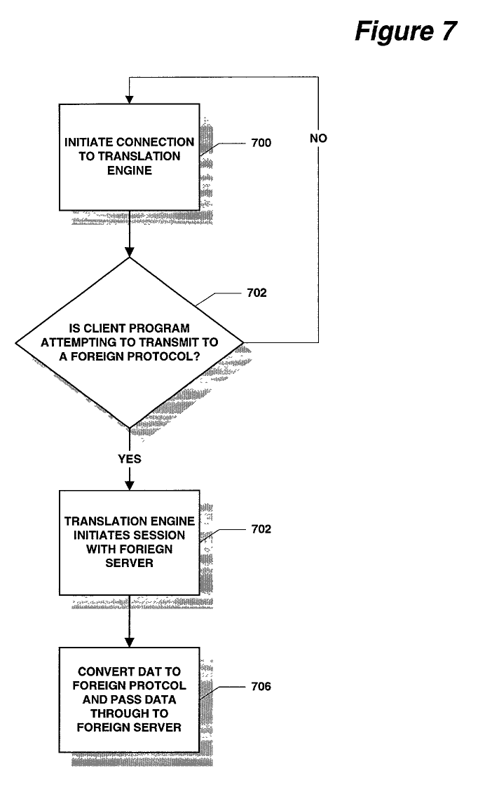

FIG. 7 illustrates the process utilized by the translation engine when the translation engine is configured to act on behalf of a client program to communicate with a foreign protocol. The process initiates when the client (e.g. an applet) program initially logs onto the translation engine (e.g. step 700). The translation engine then determines whether the client program is attempting to interface with a decided native protocol or a foreign protocol (e.g. step 702). If the client program is attempting to initiate a connection with a foreign protocol (e.g. the ICQ™ instant messaging protocol), step 704 executes and the translation engine initiates a connection to the server designated to receive communications using the foreign protocol. If for example, the client program initially transmits a message using the AOL™ instant messaging protocol, but the message is addressed to another client program configured to use the ICQ™ protocol, the translation engine will initiate a connection to the server tasked with tracking ICQ users. Once a connection is initiated with the translation engine, the translation engine executes step 706 where it passes the data through to the designated foreign server on behalf of the client program that initiated the request. Replies may be routed through the transaction server as well.

Communication Engine

The communication engine provides a mechanism for transmitting targeted messages to users the presence engine identifies as present. The communication engine also provides a way to link multiple servers together in such a way that such servers function as a single entity. An embodiment of the invention contemplates using an external agent to send time critical information to the communication engine. When the communication engine receives such information it sends that information from one user to another (e.g. one-to-one). In an embodiment of the invention, the communication engine tracks which users is present by using an internal authentication/login table.

In an embodiment of the invention, the communication engine comprises a communication component, a user information component, a presence component, an MUX component, a banner component, and/or an authentication component. The communication component provides a mechanism for the communication engine to interface with client programs and thereby provides instantaneous messaging services, online conferences, and file transfer capabilities. The user information component comprises data associated with a particular user. The user information component may, for example, comprise a user's address book, a permit/deny list and contain other engines login information and options. The presence component comprises a list of presence information that is to be published on one or more web sites. The MUX component interfaces with the translation engine and comprises a redirector for applets. The banner component comprises a mechanism for transmitting targeted advertisements to the user. In an embodiment of the invention, the banner component interfaces with the broadcast engine to provide such functionality. The authentication component comprises a mechanism for obtaining registration information and determining whether the user presenting such information is authentic.

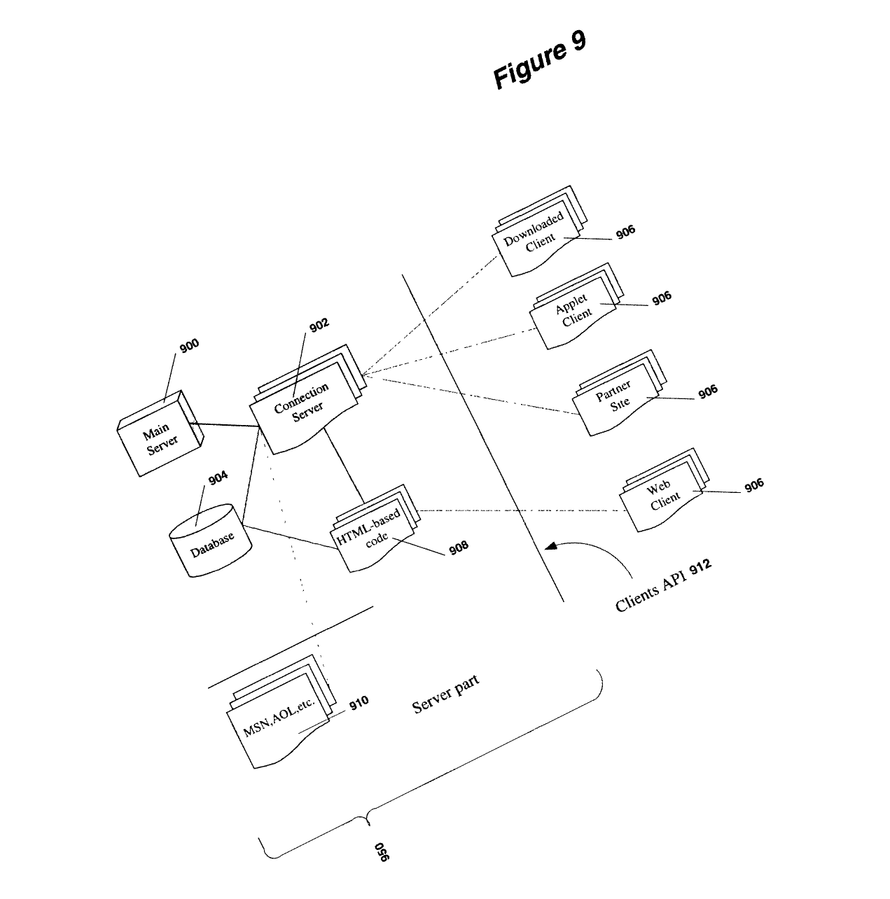

In one embodiment of the invention, the communication engine comprises multiple components. FIG. 9 illustrates the components of the communication engine 950 in one embodiment of the invention. Main server 900 is configured to connect one or more connection servers 902 together in such a way that they work as single entity. Thus, connection server 902 provides a way to instantaneously share data and database(s) 904 between components of communication engine 950. Main Server 900 may also comprise a list of online buddies and a list of those added to an address book by online users. In one embodiment of the invention, a user login name comprises the database search key, value—“buddy id” and “servers flags”. “Buddy id” contains the information on whether a buddy is online, and if so, then on which connection server. “Servers flags” informs on which servers the clients that added this buddy to their address books are. A user typically connects to connection server via client program 906. Client program 906 may comprise a downloaded client program, an applet client program, a partner site client program, or a web client program. Each client program interfaces with connection server 902 via an API 912.

Connection server 902 has access to HTML-based code 908 which may be constructed using code obtained from database 904. Connection server may also be configured to transmit data to other instant messaging providers (e.g. MSN, AOL, etc . . . 910). In one embodiment of the invention, connection server 902 comprises the following components:

Communication Component: Instant messaging, Conferences, File Transfer, . . .

User Info Component: Client's Address Book, Permit/Deny list, Another's engines login info and options.

Presence Component: Presence information to be published on Web Sites.

MUX Component: Redirector for applets (Supports connection to AOL, MSN, . . . Servers.)

Advertise Component: Banner manager

Authentication Component: Registration and login process

HTML-based code comprises registration profiles, interest groups, and other services that may be provided through the web. In one embodiment of the invention, client program 906 is a downloaded over a network and executed on a client computer (e.g. a win32 client). Client program 906 may also comprise an applet that is not operating system specific (e.g. a Java applet). In other instances client program 906 is embedded into a web site 906 and/or contained within partner site 906.

Connection server 902 typically uses a thread management scheme to maximize server performance and minimize memory allocation. Each task the server performs may be organized into groups. A single thread then iterates for the list of task and executes task actions. Each action is designed to consume minimal execution time and large tasks are separated into smaller parts.

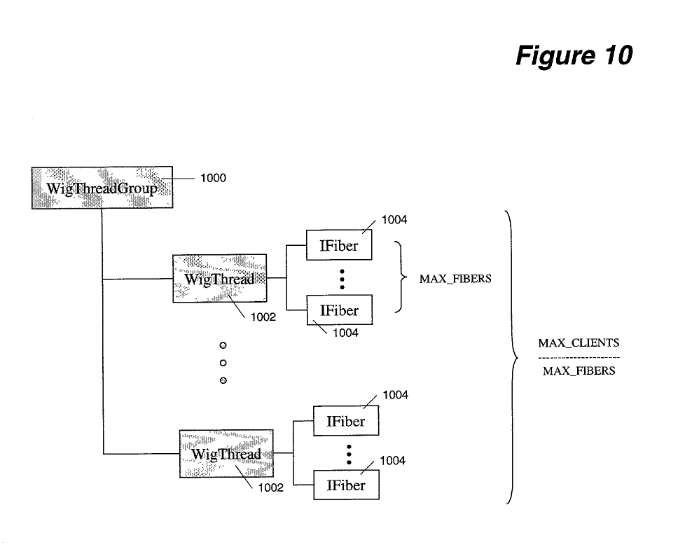

FIG. 10 illustrates the thread management scheme utilized by one embodiment of the invention. However, the invention contemplates the use of other thread management schemes to provide a server optimized for implementation of the present invention. WigThreadGroup 1000 comprises a thread manager that manages a list of tasks. WigThread 1002 comprises a single thread that manages a list of tasks. IFiber 1004 comprises a task that is to be executed. In one embodiment of the invention, all special tasks implement the IFiber 1004 interface.

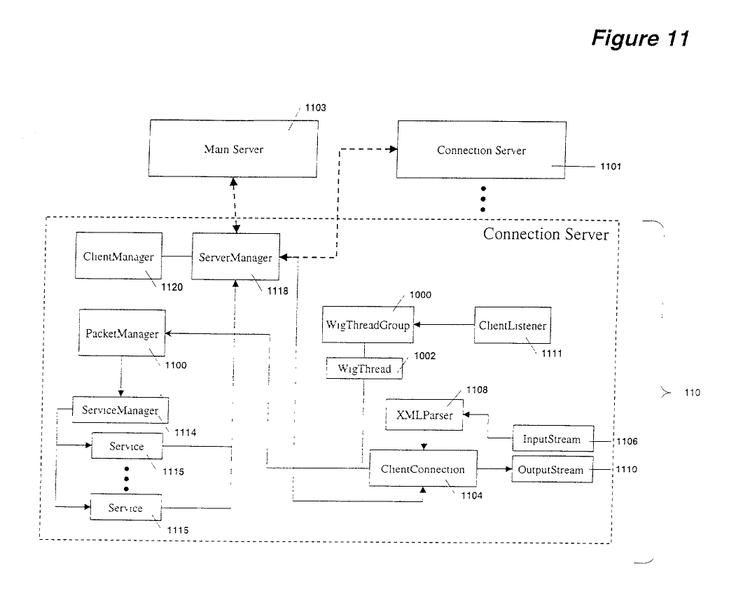

FIG. 11 illustrates the internal class structure of the connection server 1101 in one embodiment of the invention. Class PacketManager 1100 may extract packets from the queue and handle packets provided by ServiceManager 1114. Class ClientConnection 1104 has a base class Object and implements IFiber. In one embodiment of the invention, ClientConnection 1104 represents a socket connection with the client program and may read data from InputStream 1106, which is configured to parse an XML data stream using XMLParser 1108. ClientConnection 1104 also comprises a method that may be called to write outgoing packet to OutputStream 1110. ClientConnection 1104 may comprise a method to delete ClientConnection 1104 from the list of tasks and free resources. Class ClientListener 1111 comprises a ServerSocket and may accepts connections from client programs, build ClientConnection 1104 objects, and add the object to WigThreadGroup 1112 to start communication. Class XMLParser 1108 is configured to parse XML-Stream and builds XMLElements, which may contain an indivisible chunk of data. Class Service 1115 comprises an abstract class that realizes certain functionality. For example, Service 1115 comprises a method that may be called from PacketManager 1100 to process input packets. Service 1115 builds output packets and directs these packets to ServerManager 1118. Some examples of derived classes are as follows:

ServiceAuthentication—registration and login process.

ServiceMessaging—instant-messaging.

ServiceConference—conferences.

ServiceInfo—address book and other information.

ServiceFileTransfer—file transfer.

ServiceAdvertise—advertise.

ServiceAOL—AOL support.

ServiceMSN—MSN support.

Class ServiceManager 1118 comprises a list of services. Each service is associated with a list of packet names. During processing input packet ServiceManager 1118 finds corresponding service by packet name and calls packet handler. Class ServerManager 1118 manages the communication engine's connections and communicates with main server(s) 1103 and connection server(s) 1101. Server Manager 1118 may handle outgoing packets from a Service 1115, sort packets by server ID that contains packet receivers, and send packets to their servers. ServerManager 1118 may also send packets through ClientConnection 1104 if the receiver is connected to this server. In one embodiment of the invention, Server Manager 1118 receives packets from connected servers and sends them to receivers through ClientConnection 1104. ServerManager 1118 may use ClientManager 1120 to get the receiver's location. Class ClientManager 1120 is utilized to manage each client's lists. In one embodiment of the invention, Client Manager 1120 comprises a list of clients connected to this server and tracks each client's address book and permit/deny lists. ClientManager 1120 may also contain a list client ID's associated to corresponding ClientConnection 1104 and query client's ID from Main Server 1103 if it is necessary.

Class PacketIn typically comprises an XMLElement that is a complete chunk of data from client. Also it contains reference to client that is the producer of the packet (ClientConnection 1104 object). Class PacketOut comprises a complete chunk of data that is a String (XML element). Receiver is a ClientConnection 1104 reference—for clients connected to the same server, or buddy ID—for clients connected to other servers.

The invention also contemplates the use of complementary classes and interfaces such as the following:

Interface Itrace: This interface is used for debugging and tracing.

TRACE_LEVEL is used to determining debug level.

ASSERT is used to turn assertion checks to ON/OFF.

TRACE_LEVEL_NO—Seldom emerging but important messages independent on the set flags.

a) Initialization of server kernel components.

b) Critical errors in server kernel components work and important warnings.

TRACE_LEVEL_MIN—Main messages about work of various components filtered by the appropriate flags.

a) Principal stages of classes and components life.

b) Input/output errors.

TRACE_LEVEL_MAX—Detailed messages about the work of all components filtered by the appropriate flags.

Group filters: Each group filter is used to activate/deactivate trace of common process groups.

TRACE_CONSTRUCT—trace classes construction destruction.

TRACE_THREAD_RUN—trace threads start and exit.

TRACE_IO—trace input output operations.

Classes filters: Each class filter is used to activate/deactivate trace of specific class or component. Examples:

TRACE_CLASS_XMLPARSER—is used to activate deactivate traces of XML parser.

TRACE_CONSTRUCT+TRACE_CLASS_XMLPARSER determines traces of construction and destruction classes used to parsing XML.

Interface Itimer: This interface is used for setting timer for specified tasks. When the time expires timer callback function will be called. Callback function may have the following parameters:

int id;

Object param;

Class CommClient is based on ClientConnection and comprises the necessary information about client state. In one embodiment of the invention, this information is utilized for Services to determine its behavior. Buddy List

In one embodiment of the invention, buddy Lists are distributed among one or more connection servers. Each connection server comprises the buddies added to their address books the client connected to this server. Such an architecture is useful because of large number of potential buddies (e.g. 1,000,000 online*20 buddy from address book=20,000,000 buddies). Each Connection Server has its own part: 10,000 online*20 buddy from address book =200,000 buddies. In one embodiment of the invention, each buddy list is provided with access to a database stored procedures. For example, the database may contain the following stored procedures:

| | | | | Descrip- |
|---|---|---|---|---|
| Name | Type | Parameters | Returns | tion |
| q_add_buddy | U | userID | | Add |
| | | (numeric), | | buddy to |
| | | groupname | | temporary |
| | | (char), | | address |
| | | buddylogin | | book |
| | | (char), | | |
| | | buddyPID | | |
| | | (numeric), | | |
| | | engineID | | |
| | | (smallint), | | |
| | | screen_{—} | | |
| | | name (char) | | |
| q_add_buddy_direct | U | userID | | Add |
| | | (numeric), | | buddy to |
| | | groupname | | address |
| | | (char), | | book |
| | | buddylogin | | |
| | | (char), | | |
| | | buddyPID | | |
| | | (numeric), | | |
| | | engineID | | |
| | | (smallint), | | |
| | | screen_{—} | | |
| | | name (char) | | |
| q_add_deny | U | userID | | Add |
| | | (numeric), | | buddy to |
| | | buddylogin | | temporary |
| | | (char), | | deny list |
| | | buddyPID | | |
| | | (numeric), | | |
| | | engineID | | |
| | | (smallint) | | |
| q_add_deny_direct | U | userID | | Add |
| | | (numeric), | | buddy to |
| | | buddylogin | | deny list |
| | | (char), | | |
| | | buddyPID | | |
| | | (numeric), | | |
| | | engineID | | |
| | | (smallint) | | |
| q_add_permit | U | userID | | Add |
| | | (numeric), | | buddy to |
| | | buddylogin | | temporary |
| | | (char), | | permit |
| | | buddyPID | | list |
| | | (numeric), | | |
| | | engineID | | |
| | | (smallint) | | |
| q_add_permit_direct | U | userID | | Add |
| | | (numeric), | | buddy to |
| | | buddylogin | | permit |
| | | (char), | | list |
| | | buddyPID | | |
| | | (numeric), | | |
| | | engineID | | |
| | | (smallint) | | |
| q_get_access | Q | userID | access - | Get users |
| | | (numeric) | smallint | access |
| | | | | flag |
| | | | | (permit, |
| | | | | deny, etc.) |
| q_get_book | Q | userID | userID - | Get users |
| | | (numeric), | numeric, | address |
| | | partnerID | group_name - | book by |
| | | (numeric), | char, engineID- | user ID or |
| | | login | smallint, | partnerID |
| | | (char) | partnerID - | and login. |
| | | | numeric, | The one |
| | | | login - | parameter |
| | | | char, | can be |
| | | | screen_name - | empty |
| | | | char | (−1). |
| q_get_buddyid | Q | buddyPID | buddyID - | Regis- |
| | | (numeric), | numeric | tering |
| | | login | | new |
| | | (char) | | buddy |
| | | | | in to |
| | | | | Address- |
| | | | | Book- |
| | | | | Buddy |
| | | | | table and |
| | | | | get buddy |
| | | | | ID |
| q_get_emailbyid | Q | UserID | Email - char | Get users |
| | | (numeric) | | email by |
| | | | | users ID |
| q_get_emailbylogin | Q | partnerID | Email - char | Get users |
| | | (numeric), | | email by |
| | | login | | users |
| | | (char) | | partner ID |
| | | | | and users |
| | | | | login |
| q_get_groupid | Q | groupname | groupID - | Regis- |
| | | (char) | numeric | tering |
| | | | | new group |
| | | | | name in to |
| | | | | Address- |
| | | | | Book- |
| | | | | Group |
| | | | | table and |
| | | | | get group |
| | | | | ID |
| q_get_logininfo | Q | UserID | Login_Name- | Get users |
| | | (numeric), | char, Password | login info |
| | | ServiceName | - char, Flags - | by other |
| | | (char[aol | smallint, Host - | services |
| | | \|msn\|ubiq | char (only for | |
| | | ue]) | MSN) | |
| q_get_partner_pass | Q | login (char) | partnerID - | Get |
| word | | | numeric | partner |
| | | | password - char | password |
| | | | | by partner |
| | | | | login |
| q_get_password | Q | partnerID | userID - | Get client |
| | | (int), login | numeric | password |
| | | (char) | password - char | by client |
| | | | | login |
| q_get_sorted_book | Q | userID | id - numeric | Get |
| | | (numeric) | (0/1) | sorted |
| | | | name - char | client |
| | | | partnerID - | address |
| | | | numeric | book |
| | | | engineID - | |
| | | | smallint | |
| | | | screen_name - | |
| | | | char | |
| q_get_stamp | Q | userID | smallint | Get client |
| | | (numeric) | | save |
| | | | | stamp by |
| | | | | client ID |
| q_invitation_step1 | Q | Login | User_ID - | |
| | | (varchar), | numeric, | |
| | | partnerID | Login_Name - | |
| | | (int) | char, | |
| q_invitation_step2 | Q | Buddy email | Partner_ID | |
| | | (varchar) | - numeric, Full | |
| q_invitation_step3 | Q | Buddy name | Name - char | |
| | | (varchar) | | |
| q_invitation_step4 | Q | Interest | | |
| | | group name | | |
| | | (varchar) | | |
| q_register_partner | U | partnerID | | Register |
| | | (numeric), | | new |
| | | name (char), | | partner |
| | | password | | |
| | | (char) | | |
| q_register_user | Q | partnerID | userID - | Register |
| | | (numeric), | numeric | new |
| | | login (char), | | user |
| | | password | | |
| | | (char), | | |
| | | email (char) | | |
| q_remove_buddy_di | U | userID | | Remove |
| rect | | (numeric), | | buddy |
| | | groupname | | from |
| | | (char), | | address |
| | | buddylogin | | book |
| | | (char), | | |
| | | buddyPID | | |
| | | (numeric), | | |
| | | engineID | | |
| | | (smallint) | | |
| q_remove_deny_dir | U | userID | | Remove |
| ect | | (numeric), | | buddy |
| | | buddylogin | | from |
| | | (char), | | deny list |
| | | buddyPID | | of user |
| | | (numeric), | | |
| | | engineID | | |
| | | (smallint) | | |
| q_remove_permit_di | U | userID | | Remove |
| rect | | (numeric), | | buddy |
| | | buddylogin | | from |
| | | (char), | | permit |
| | | buddyPID | | list of |
| | | (numeric), | | user |
| | | engineID | | |
| | | (smallint) | | |
| q_remove_user | U | userID | | Remove |
| | | (numeric) | | user from |
| | | | | database |
| q_save_book | U | userID | | Move data |
| | | (numeric) | | from |
| | | | | temporary |
| | | | | address |
| | | | | book to |
| | | | | real AB |
| q_session_end | U | UserID | | End of |
| | | (numeric), | | users |
| | | SessionID | | session |
| | | (numeric), | | |
| | | time | | |
| | | (datetime), | | |
| | | stat_enable | | |
| | | (bit) | | |
| q_session_start | Q | UserID | SessionID - | Start of |
| | | (numeric), | numeric | users |
| | | onlineID | | session |
| | | (numeric), | | |
| | | time | | |
| | | (datetime), | | |
| | | ipaddress | | |
| | | (int), | | |
| | | clientType | | |
| | | (varchar), | | |
| | | stat_enable | | |
| | | (bit) | | |
| q_set_access | Q | userID | access - | Set users |
| | | (numeric) | smallint | access |
| | | | | flag |
| | | | | (permit, |
| | | | | deny, etc.) |
| q_set_logininfo | U | UserID | | Set users |
| | | (numeric), | | login info |
| | | ServiceName | | for other |
| | | (char [aol | | services |
| | | \|msn\| | | |
| | | ubique]), | | |
| | | Login (char), | | |
| | | Password | | |
| | | (char), | | |
| | | Flags | | |
| | | (smallint), | | |
| | | Host (char) | | |
| q_statistic_broadcast | U | UserID | | Set users |
| | | (numeric), | | brocast |
| | | timeSent | | statistic |
| | | (datetime), | | |
| | | timeReach | | |
| | | (datetime), | | |
| | | timeLeave | | |
| | | (datetime) | | |
| q_statistic_comm | U | SessionID | | Set users |
| | | (numeric), | | commun- |
| | | onlineID | | ication |
| | | (numeric), | | statistic |
| | | actionType | | |
| | | (smallint), | | |
| | | numberOut | | |
| | | (numeric) | | |

FIG. 12 illustrates the architectural interface between servers used by an embodiment of the invention. The interface utilizes a number of different procedures to communicate between servers. For example, the interface may comprises the following procedures:

Connect to Main Server procedure:

1. Connection Server 1200 may send a connect 1204 command and public port listening for cserver connection

2. Main Server 1202 may reply with connect 1204 command and let known cserver id & ip/port of running cservers

Signon buddy procedure:

1. Connection Server 1200 sends command updatebuddy 1206.

2. Main Server 1202 sends command updatebuddy 1206.

3. Connection Server 1200 send command updatebuddy 1206 other Connection Servers 1200.

4. If Connection Server 1200 received command updatebuddy 1206 from Connection Server 1200 and ID of!=−1 and ID of state==ST_OFFLINE then it send command access 1208.

Add and remove buddy from AB procedure:

1. Connection Server 1200 sends command addbuddy 1212 or removebuddy 1214.

2. If Main Server received command addbuddy 1212 then it sends command updatebuddy 1206.

Send message 1210 from buddy which present on other Connection Server 1200:

1. Connection Server sends command getid 1216.

2. Main Server sends command getid 1216.

3. Connection Server send command message 1210 other Connection Servers 1200

Authentication and Co-registration servers:

In one embodiment of the invention one or more authentication and coregistration servers are created. Each server is configured to allow

(i) a client to connect to the Connection server(s) and query for miscellaneous information: address book, profile, etc. Also the client may store changes back to the database. This type of connection typically requires user name (nickname)/password to connect.

In accordance with one embodiment of the invention, the communication server supports “loginless” guest accounts that allow users to get a temporary id so that the user can send IMs. Each registered user has an associated partner ID that provides information about the destination from which the user came from. Internally, user name may be stored as <PartnerID><nickname>, so it'll be possible to have the same nicknames for different partners.

Broadcast Engine

Broadcast engine 166 is configured to transmit a message from one user to many users according to a set of criteria. For example, stock quotes, the closing information related to an auction the user is interested in, or any other information the user expresses an interest in receiving may be transmitted from one user to another using the communication engine. The broadcast engine 166 may deliver a single message to many users by generalizing the message into a one-to-many message. The criteria used to determine which recipients to transmit the message data to may be based on membership in a group, demographic information, or any other type of filtering criteria. In one embodiment of the invention, the messages transmitted by broadcast engine 166 comprise advertisements and/or other information to user who are online. Thus, broadcast engine 166 may instantaneously transmit messages to any members of a group who are online (e.g. via an instant messaging client). If the members of that group are not presently online, broadcast engine 166 may automatically send the message data via electronic mail. Each message may contain functionality that allows the user to fashion a response to the message. The message may, for example, contain an embedded coupon that allows the receiving user to receive a discount on a particular item if the user clicks on the message. Message recipients may also subscribe to a service by selecting the message.

Embodiment of General Purpose Computer Environment:

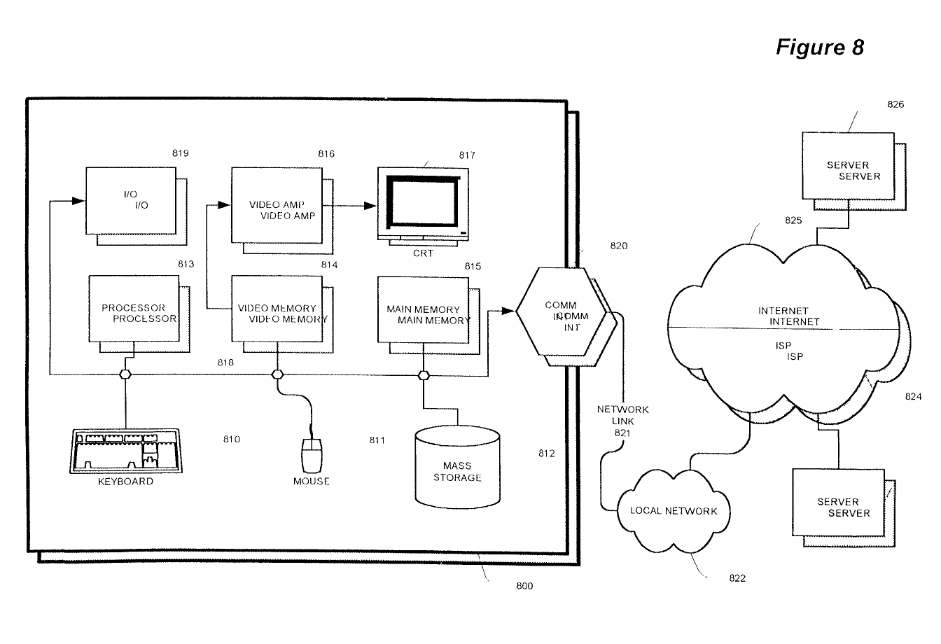

An embodiment of the invention can be implemented as computer software in the form of computer readable program code executed on one or more general-purpose computers such as the computer 800 illustrated in FIG. 8. A keyboard 810 and mouse 811 are coupled to a bi-directional system bus 818 (e.g., PCI, ISA or other similar architecture). The keyboard and mouse are for introducing user input to the computer system and communicating that user input to central processing unit (CPU) 813. Other suitable input devices may be used in addition to, or in place of, the mouse 811 and keyboard 810. I/O (input/output) unit 819 coupled to bi-directional system bus 818 represents possible output devices such as a printer or an A/V (audio/video) device.

Computer 800 includes video memory 814, main memory 815, mass storage 812, and communication interface 88. All these devices are coupled to a bi-directional system bus 818 along with keyboard 810, mouse 811 and CPU 813. The mass storage 812 may include both fixed and removable media, such as magnetic, optical or magnetic optical storage systems or any other available mass storage technology. The system bus 818 provides a means for addressing video memory 814 or main memory 815. The system bus 818 also provides a mechanism for the CPU to transferring data between and among the components, such as main memory 815, video memory 814 and mass storage 812.

In one embodiment of the invention, the CPU 813 is a microprocessor manufactured by Motorola, such as the 680X0 processor, an Intel Pentium III processor, or an UltraSparc processor from Sun Microsystems. However, any other suitable processor or computer may be utilized. Video memory 814 is a dual-ported video random access memory. One port of the video memory 814 is coupled to video accelerator 816. The video accelerator device 816 is used to drive a CRT (cathode ray tube), and LCD (Liquid Crystal Display), or TFT (ThinFilm Transistor) monitor 817. The video accelerator 816 is well known in the art and may be implemented by any suitable apparatus. This circuitry converts pixel data stored in video memory 814 to a signal suitable for use by monitor 817. The monitor 817 is a type of monitor suitable for displaying graphic images.

The computer 800 may also include a communication interface 88 coupled to the system bus 818. The communication interface 88 provides a two-way data communication coupling via a network link 821 to a network 822. For example, if the communication interface 820 is a modem, the communication interface 820 provides a data communication connection to a corresponding type of telephone line, which comprises part of a network link 821. If the communication interface 820 is a Network Interface Card (NIC), communication interface 820 provides a data communication connection via a network link 821 to a compatible network. Physical network links can include Ethernet, wireless, fiber optic, and cable television type links. In any such implementation, communication interface 820 sends and receives electrical, electromagnetic or optical signals which carry digital data streams representing various types of information.

The network link 821 typically provides data communication through one or more networks to other data devices. For example, network link 821 may provide a connection through local network 822 to a host computer 823 or to data equipment operated by an Internet Service Provider (ISP) 824. ISP 824 in turn provides data communication services through the world wide packet data communication network now commonly referred to as the “Internet” 825. Local network 822 and Internet 825 both use electrical, electromagnetic or optical signals that carry digital data streams to files. The signals through the various networks and the signals on network link 821 and through communication interface 820, which carry the digital data to and from computer 800, are exemplary forms of carrier waves for transporting the digital information.

The computer 800 can send messages and receive data, including program code, through the network(s), network link 821, and communication interface 820. In the Internet example, server 826 might transmit a requested code for an application program through Internet 825, ISP 824, local network 822 and communication interface 820.

The computer systems described above are for purposes of example only. An embodiment of the invention may be implemented in any type of computer system or programming or processing environment.

Thus, a method and apparatus for utilizing online presence information has been described. Particular embodiments described herein are illustrative only and should not limit the present invention thereby. The claims and their full scope of equivalents define the invention.

1. A method for utilizing online presence information comprising:
generating a presence indicator associated with a receiving user;
determining if said receiving user connected to an interconnection fabric;
displaying said presence indicator in a document to an initiating user;
providing an instantaneous communication interface to said initiating user when said presence indicator is selected and said receiving user is connected to said interconnection fabric;
providing a message interface to said initiating user when said presence indicator is selected by said initiating user and said receiving user is not connected to said interconnection fabric.
